(19) United States
(12) Patent Application Publication
(10) Pub. No.: US 2008/0308183 A1
(43) Pub. Date: Dec. 18, 2008

(54) SATELLITE DOSING SYSTEM

(76) Inventor: Brian R. Law, Leicester (GB)

Correspondence Address: WOODARD, EMHARDT, MORIARTY, MCNETT & HENRY LLP, 111 MONUMENT CIRCLE, SUITE 3700, INDIANAPOLIS, IN, 46204-5137, US

(21) Appl. No.: 12/140,440

(22) Filed: Jun. 17, 2008

Related U.S. Application Data
(60) Provisional application No. 60/936,162, filed on Jun. 18, 2007.

(51) Int. Cl. B65B 1/04; B67D 5/06

(52) U.S. Cl. 141/380; 222/205

(57) ABSTRACT

One embodiment of a satellite dosing system as disclosed includes a closure that is attached to a container in combination with a dosing module that is removable from the remainder of the closure for the dispensing of a volume of liquid product at the point of use.

### CROSS REFERENCES TO RELATED APPLICATIONS

The present application claims the benefit of U.S. Provisional Patent Application Ser. No. 60/936,162, filed Jun. 18, 2007, entitled “SATELLITE DOSING SYSTEM” which is hereby incorporated by reference in its entirety.

### BACKGROUND OF THE INVENTION

The concept of a “satellite” dosing system involves dispensing a first volume of a flowable material or product from a larger volume or supply into a smaller dispensing module. In one arrangement, this smaller module is constructed and arranged to be removable from the container holding the larger volume. Alternatively, the smaller module can be fixed to the container and the measured volume of product in the smaller module dispensed by lifting and tilting the entire container. Alternatively, a combination of the two is contemplated wherein the smaller module can be used remote from the larger container or can be used while fixed to the container.

Some of the likely products for dispensing from this type of satellite dosing system include laundry products, such as liquid detergents and fabric softeners, and herbicides, such as liquid weed killer, for example.

An earlier version of the satellite dosing system disclosed herein was directed to a module that would provide a product measure, such as a laundry powder, and be suitable to be placed in the washing machine. This earlier version led to the conception of a satellite module for a liquid product that would be mounted or attached to the top of a larger bottle or container that is constructed and arranged for squeezing liquid product directly into the satellite module by way of a transfer conduit or fill tube. One design issue that was addressed in the process of the evolving conception and design modifications related to leaving the main (larger) container open once the satellite module was removed. While options for closing the top of the larger container (when the satellite module was in use) were considered, each design concept involved a requirement for additional parts and/or more involved design configurations that in turn were considered to be too expensive to incorporate into this overall design. Other, prior conceptual work involved the dosing of a motor oil additive with dispensing concepts similar to the other (earlier) conceptions, as described above, but without making the dosing (satellite) module removable from the larger (supply) container. Consideration of the various structural features and relationships of the conceptions suggested that the liquid filling of the satellite module could be used as envisioned, still with a removable module, but a module that would be returned to the container for closing and sealing of the container following the step of dispensing. This particular design approach would seem to solve any shipping and/or spillage concerns while still keeping the overall construction fairly simple. Further, the larger supply container would not have to be lifted. One would simply squeeze the larger container as the way to fill the satellite module while that module is still attached to the top of the container. The module is then removed, the product dispensed, and the module returned to the container for closing and sealing.

While visualizing how these conceptual ideas, theories, and embodiments might be accomplished in the form of various structural embodiments and functioning products, the devices disclosed herein were evolved.

### BRIEF SUMMARY

One embodiment of a satellite dosing system as disclosed includes a closure that is attached to a container in combination with a dosing module that is removable from the remainder of the closure for the dispensing of a volume of liquid product at the point of use.

### BRIEF DESCRIPTION OF THE SEVERAL VIEWS OF THE DRAWINGS

FIG. 1 is a perspective view of a closed product container in combination with a satellite dosing module according to the present invention.

FIG. 2 is a perspective view of the FIG. 1 container in the filling mode.

FIG. 3 is an exploded view of the FIG. 1 container with the satellite dosing module removed from the container closure.

FIG. 4 is a front elevational view, in full section, of the FIG. 1 satellite dosing module in a closed condition.

FIG. 5 is a rear elevational view of the FIG. 1 container with the satellite dosing module in a filling position.

FIG. 6 is a perspective view of a closed container in combination with a satellite dosing module according to another embodiment of the present invention.

FIG. 7 is a perspective view of the FIG. 6 container with the satellite dosing module in a position for filling.

FIG. 8 is a perspective view of the FIG. 6 satellite dosing module as attached to the container in the closed condition.

FIG. 9 is a perspective view, in full section, of the FIG. 7 satellite dosing module in the position for filling.

FIG. 10 is a partial, perspective view of the FIG. 6 container as being tilted for product dispensing from the satellite dosing module.

FIG. 11 is a perspective view of a closed container in combination with a satellite dosing module according to another embodiment of the present invention.

FIG. 12 is a perspective view of the FIG. 11 container with the satellite dosing module in a position for filling by syringe action.

FIG. 13 is a partial, perspective view of the FIG. 11 container with the satellite dosing module in a closed condition.

FIG. 14 is a partial, perspective view of the FIG. 12 container with the satellite dosing module in a filling position.

FIG. 15 is an enlarged, perspective view of the interior connection between the satellite dosing module and the container closure.

FIG. 16 is a perspective view of the satellite dosing module as removed from the container closure.

FIG. 17 is a perspective view of a closed container in combination with a satellite dosing module according to another embodiment of the present invention.

FIG. 18 is a perspective view of the FIG. 17 container with the satellite dosing module in position for filling.

FIG. 19 is a front elevational view of the FIG. 17 container with the satellite dosing module in a closed condition.

FIG. 20 is a perspective view of the FIG. 17 satellite dosing module as removed from the container closure.

FIG. 21 is a front elevational view, in full section, of an alternate embodiment corresponding to the FIG. 1 satellite dosing module.

FIG. 22 is a front elevational view, in full section, of the FIG. 21 satellite dosing module as open and filled with product from the supply container.

FIG. 23 is a front elevational view of the FIG. 1 satellite dosing module with additional design refinements and volume markings.

FIG. 24 is a perspective view of the FIG. 23 satellite dosing module, illustrated in full section so as to show internal features.

### DETAILED DESCRIPTION

For the purposes of promoting an understanding of the disclosure, reference will now be made to the embodiments illustrated in the drawings and specific language will be used to describe the same. It will nevertheless be understood that no limitation of the scope of the disclosure is thereby intended, such alterations and further modifications in the illustrated device and its use, and such further applications of the principles of the disclosure as illustrated therein being contemplated as would normally occur to one skilled in the art to which the disclosure relates.

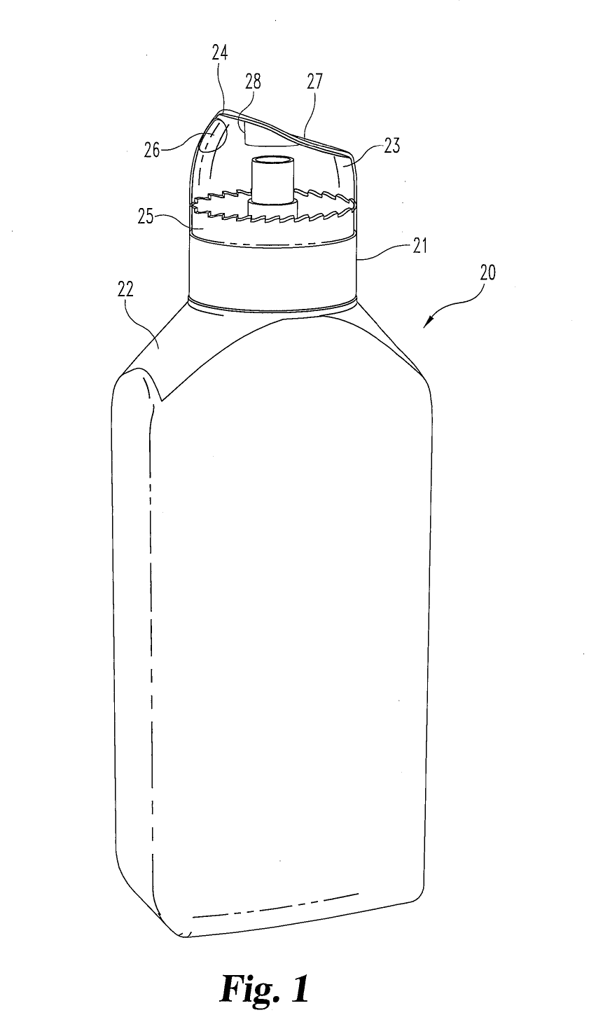

Referring to FIGS. 1-5, the overall system includes three primary components, two of which comprise the doser 20 that is the focus of this disclosure, including the alternative doser embodiments disclosed herein. While the container (the third primary component) becomes an important part of the overall structure, for the most part the container construction is conventional, providing an externally threaded neck opening for attachment of the doser components. While some shaping of the neck portion of the container may be important for the desired interfit, each container disclosed herein is basically a conventional design with an eternally-threaded neck.

With continued reference to FIGS. 1-5, the doser 20 comprises a closure 21 that is screwed to the top of the container 22 and preferably includes ratchet features fitted internally in order to prevent the closure 21 from being removed from the container neck opening. The satellite module 23 which is somewhat cylindrical in this embodiment might be considered to have a bowl-like configuration. Module 23 comprises a clear top portion 24 and an opaque bottom section 25. Portion 24 and bottom section 25 are permanently snapped together. The clear top portion 24 has an opening 26 in its upper sidewall area 27 through which liquid can be poured out. The construction of clear top portion 24 also includes a short cylindrical form 28 that is molded into the inside of the top surface in order to re-direct the flow of incoming liquid downwards. The center spigot 32 in the bottom section 25 contains an internally-threaded section 33 that enables it to be screwed onto the spout 34 of closure 21.

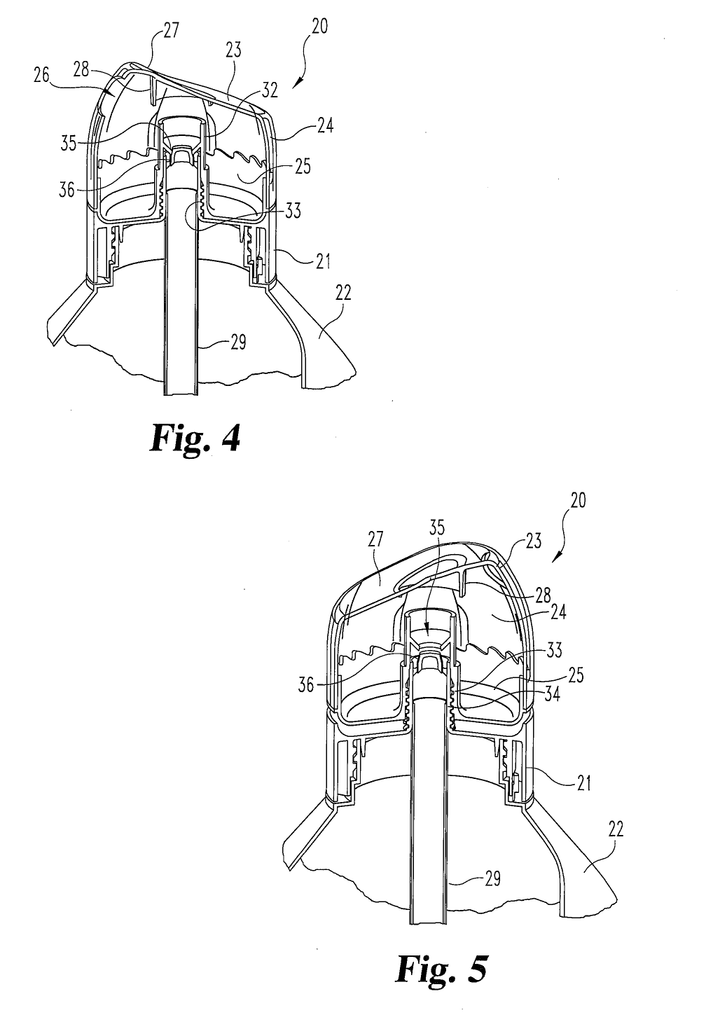

When module 23 is fully and tightly screwed onto closure 21, their abutting surfaces are drawn into tight engagement. This abutment creates a sealed interface in the event there is a potential for fluid leakage from the container to the outer surface of closure 21. When tip 36 is seated into opening 35, the dispensing path is closed (see FIG. 4). When the opening 35 is moved away from tip 36, out of seated engagement, a flow path is created.

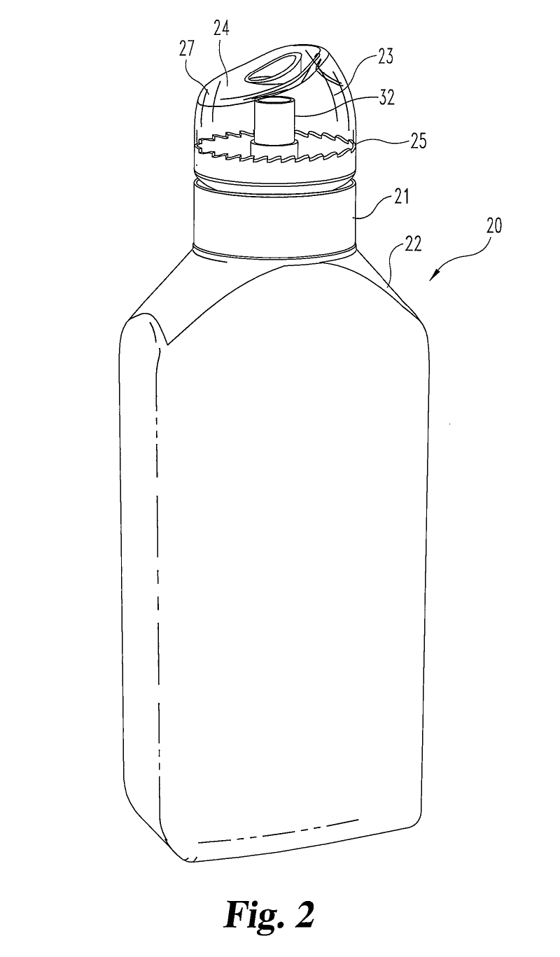

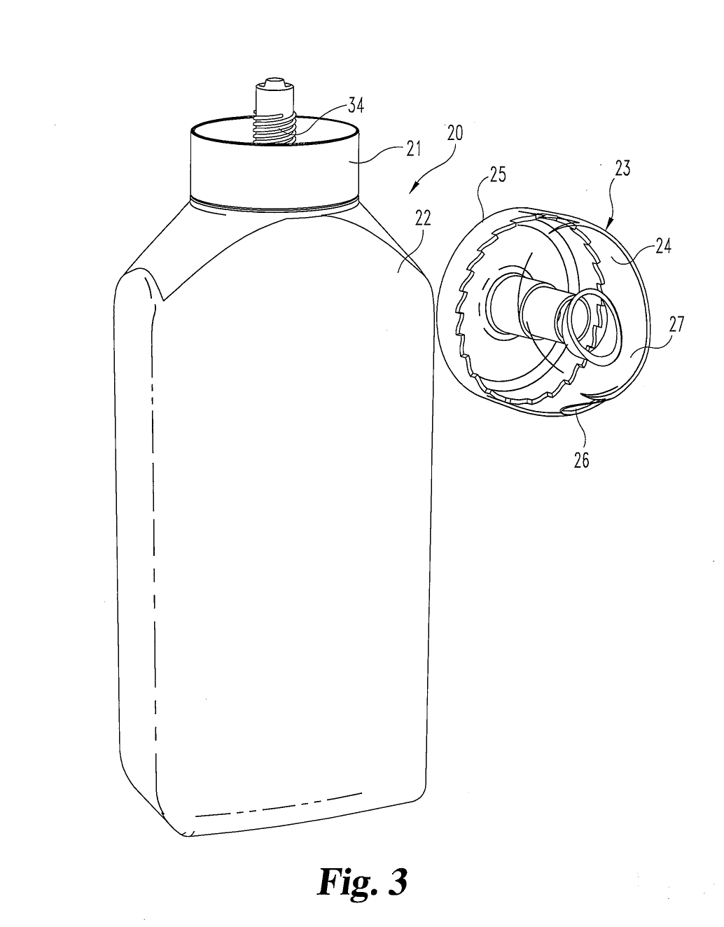

When the module 23 is partially unscrewed (typically one turn), see FIGS. 2 and 5, a flow path is open so that squeezing the container 22 allows liquid to flow from the container up through the fill tube 29 and into the module 23. When squeezing of the container 22 stops, air is drawn back into the container along with any liquid that may be left in the pathway. The module 23 can be further unscrewed and removed from the closure (see FIG. 3) and the dose of product delivered to its point of use by way of the dispensing opening 26. The module 23 can be cleaned out under a flow of tap water and then returned and screwed back onto the closure 21 in order to seal the container 22 closed (see FIGS. 1 and 4).

There is maximum amount of liquid that can be dispensed from the module 23 and this is controlled by the height of the central spigot 32. Any liquid squeezed into the module 23 that is above this level is drawn back into the container 22 when the squeezing of the container stops and air is drawn back into the container.

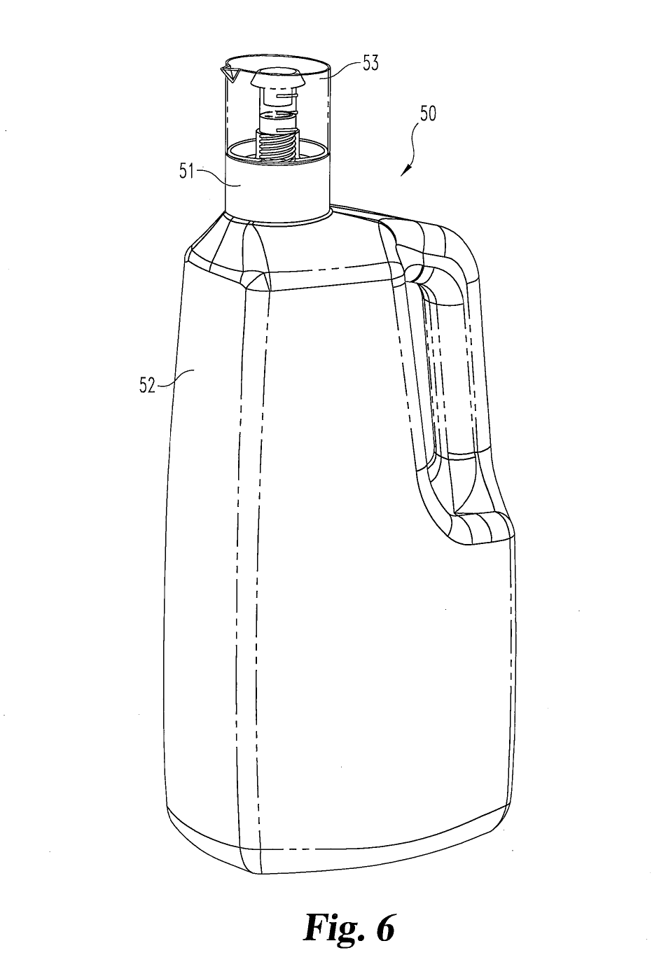

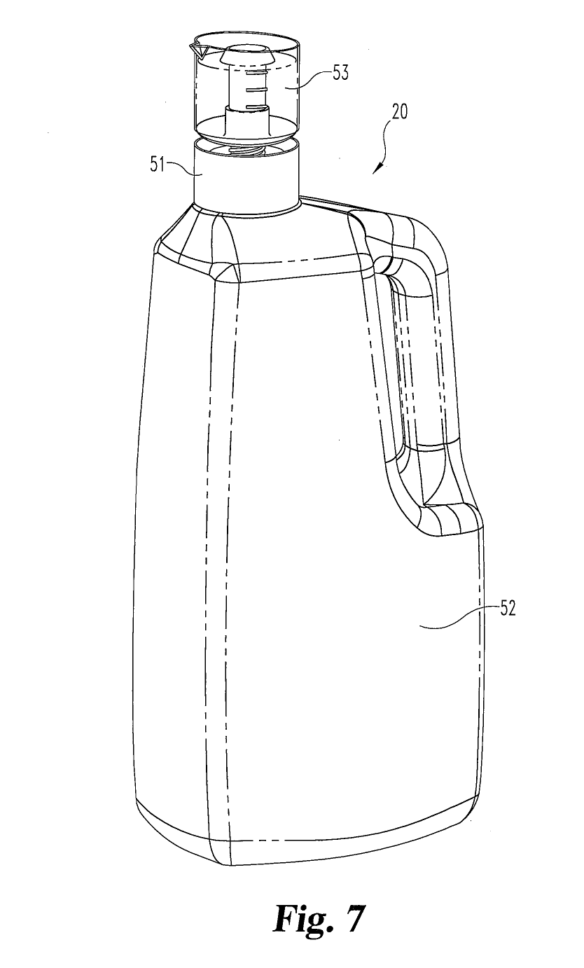

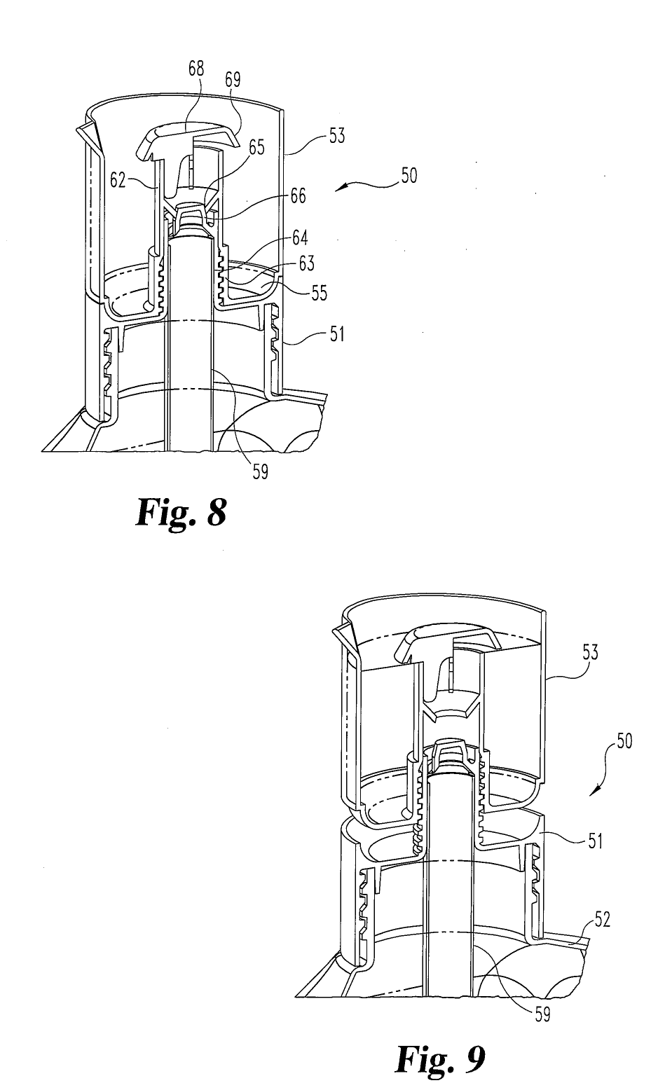

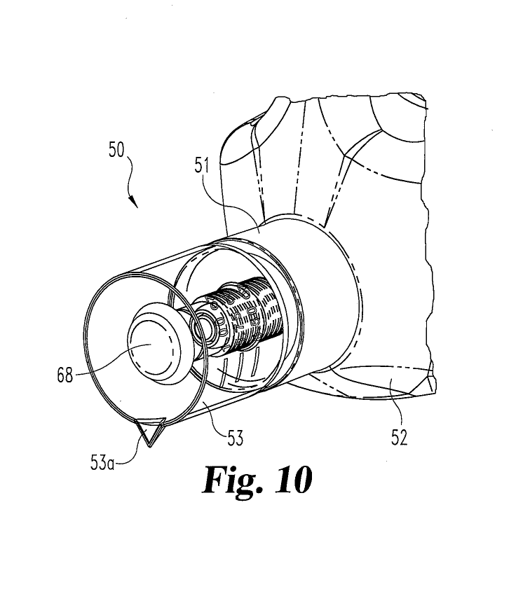

For the purposes of the reference numbers used in FIGS. 6-10, 50 and 60 series numbers are used to identify the same and/or virtually identical component parts based on the illustrations of FIGS. 1-5. In other words, component parts that are considered to be virtually identical or at least are functionally equivalent in most respects are similarly numbered with a 30 difference. For example, center spigot 62 generally corresponds in form, fit, and function to central spigot 32.

Referring now to FIGS. 6-10, another embodiment of the present invention is illustrated. The doser 50 comprises a closure 51 that is screwed to the top of container 52 and, as with doser 20, closure 51 will preferably include ratchet features fitted internally in order to prevent the closure from being removed from the container 52. The satellite module 53 is generally cylindrical and while similar in most respects to satellite module 23, module 53 is open at the top and shaped with a pouring spout 53a. Module 53 is otherwise virtually identical to module 23. Similarly, closure 51 is virtually identical to closure 21. The container 52 is also virtually identical to container 22 and like container 22, container 52 can assume a variety of shapes and volumes, all with a somewhat standard configuration in terms of its externally-threaded neck opening.

Additionally, the center spigot 62 is fitted with a dosing cap 68 that inserts into the end of spigot 62. An umbrella-shaped upper portion 69 is spaced from spigot 62 in order to provide a flow path for the product being squeezed from the larger container 52 into the module 53. If an excess amount of product happens to be squeezed into the module 53, it is automatically sucked back into the container. The dose of product can be delivered to the point of use, either by lifting and tipping the entire container 52 with the module 53 attached or by detaching the module 53 and moving it to the site of dispensing or application.

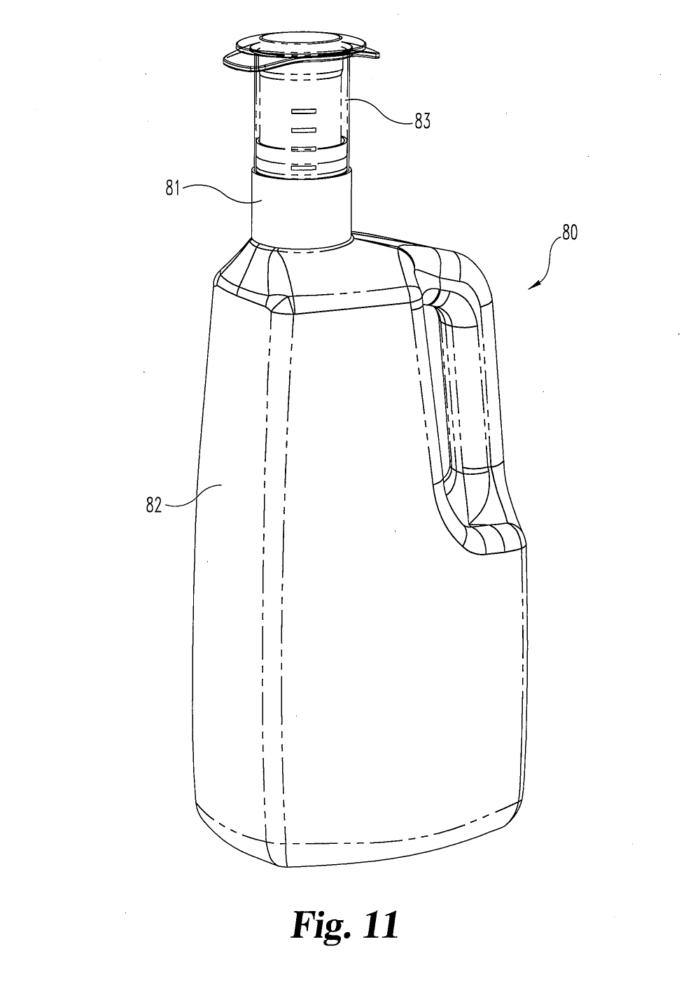

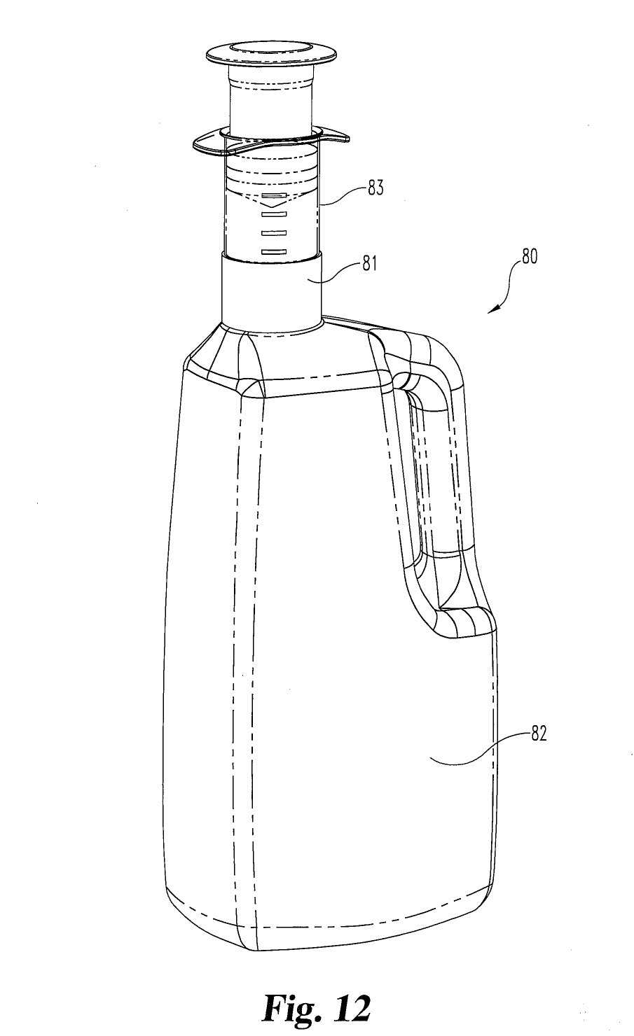

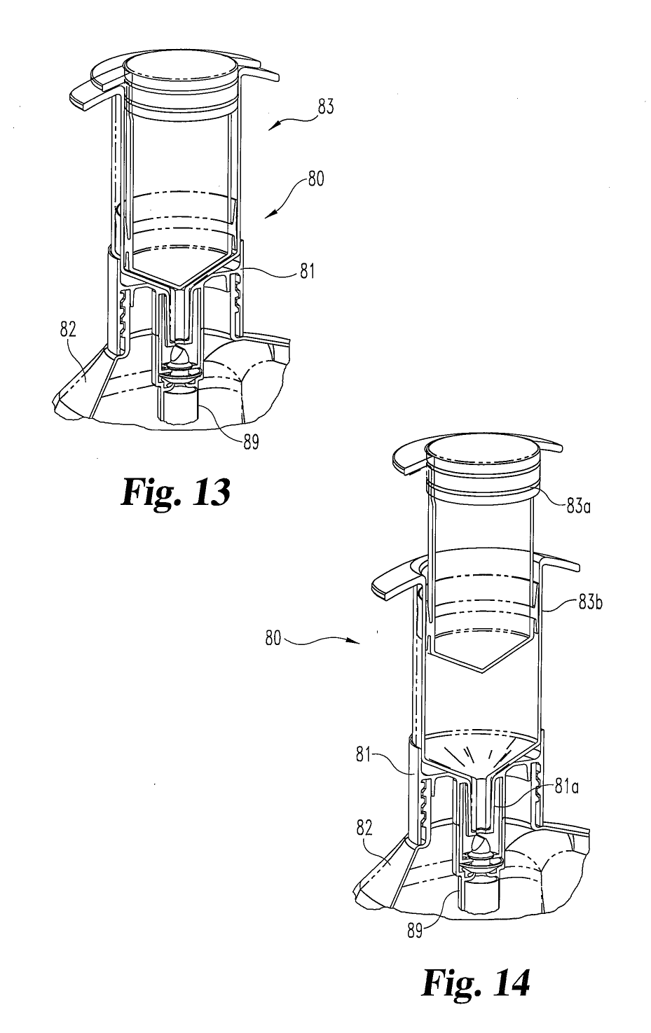

Referring to FIGS. 11-16, another embodiment of the present invention is illustrated. The doser 80 of FIGS. 11-16 uses a syringe 83 instead of the style of module 23 of doser 20 or of the style of module 53 of doser 50. Instead of squeezing the larger container 82 as the means for pushing product into the satellite module 83, the plunger 83a of the syringe is pulled back, at least partially pulling it from within the body 83b. The remainder of the construction, as disclosed for and associated with doser 20 (FIGS. 1-5) and doser 50 (FIGS. 6-10) is virtually the same for doser 80, except as noted herein.

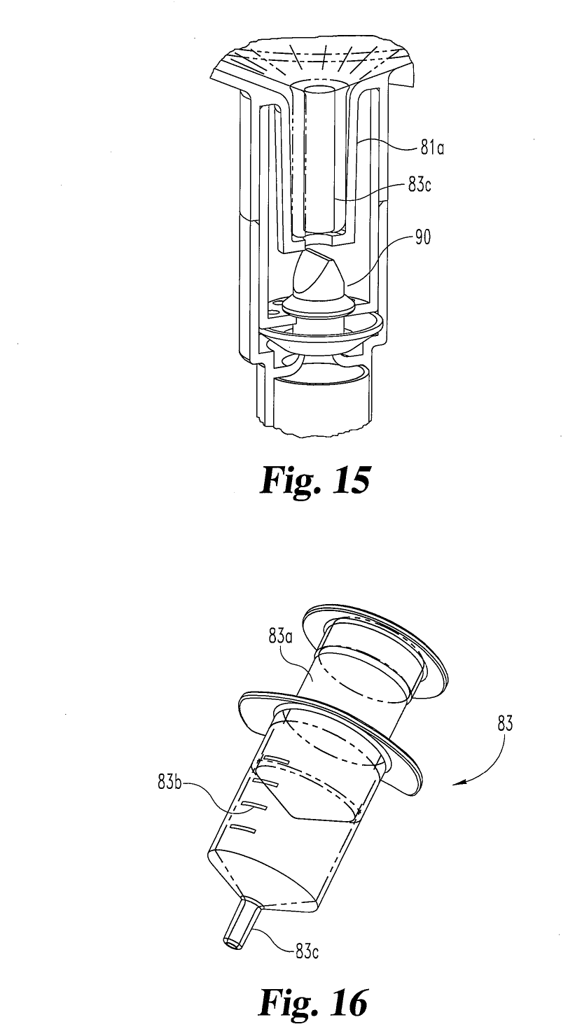

One of the features of the syringe structure for module 83 is improved measuring and dosing accuracy. The module body 83b includes volume markings on its outer surface, see FIG. 16. The syringe tip 83c is constructed and arranged as a “Luer” connector and this structure is used and securely inserted into a correspondingly shaped portion 81a of closure 81, see FIG. 15. Product is drawn out of container 82 by withdrawing the plunger 83a until the required dose is drawn into the syringe module 83. The combination duckbill/umbrella valve 90 prevents drain back into the container 82 and allows air to return after the syringe module 83 is removed by a twisting/pulling action. When free of the container 82, the syringe module 83 can be used anywhere.

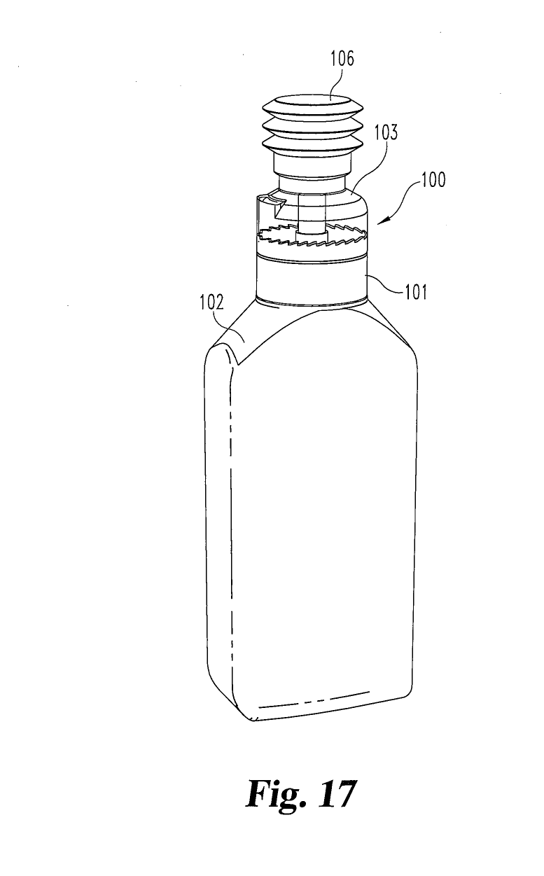

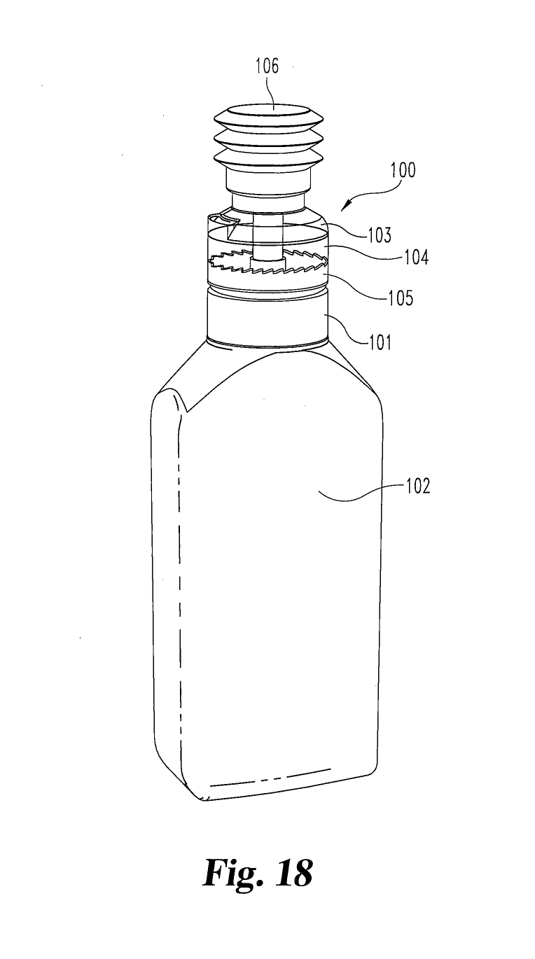

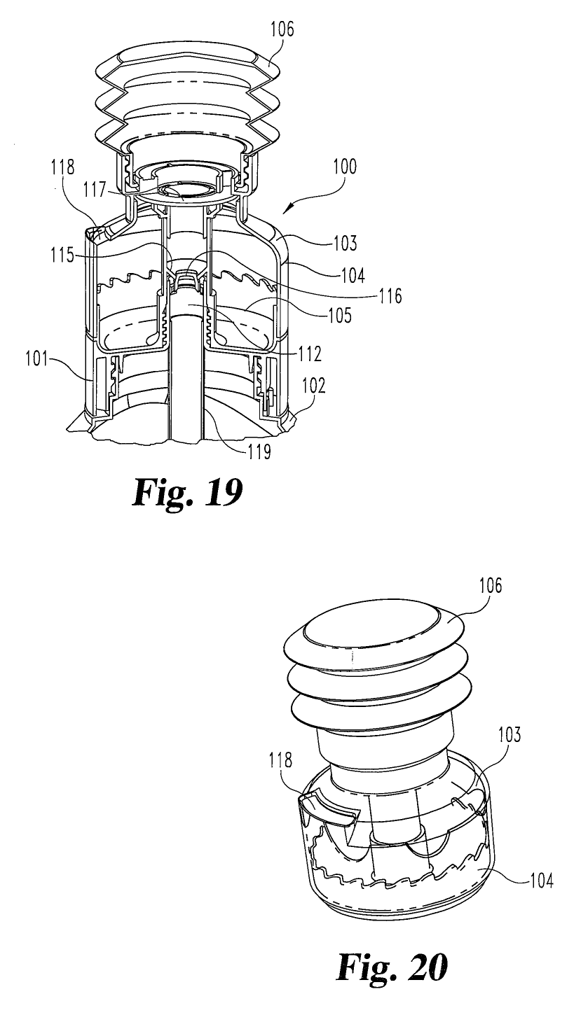

Referring to FIGS. 17-20, another embodiment of the present invention is illustrated. Doser 100 is similar in certain respects to doser 80 as illustrated in FIGS. 11-16. Doser 100 uses a bellows construction for satellite module 103 in lieu of the syringe construction of module 83. Doser 100 includes a closure 101 that is attached to the container 102 in the manner already described relative to dosers 20, 50, and 80. The module 103 includes a clear top (outer) portion 104 and an opaque bottom section 105 that are snapped together. The bellows portion 106 is fitted onto and securely attached to the clear top (outer) portion 104. The FIG. 19 drawing provides the best illustration of the relationship between portion 104 and section 105.

When the module 103 is unscrewed from the closure 101 by one full turn, the opening 115 moves away from tip 116 and this provides a flow path for product to flow from the container 102 into the module 103. Positioned between center spigot 112 and the bellows portion 106 is a combined two-way, inlet/outlet valve 117. Air passes in one direction to vent and a suction is drawn in the other direction. Pushing the bellows portion 106 so as to collapse the corrugations pushes air out via opening 118 in clear portion 104. Then, by extending the collapsed bellows portion 106, a suction is drawn on the container 102 by way of fill tube 119 and product fills the module 103. The sizing of the bellows portion 106 controls the maximum amount of product that can be extracted from the container.

The module 103 can be detached from the container 102 by a further quarter turn and lifting off of the container 102 so that the measured volume of product that was transferred to the module 103 can be delivered to its point of use, and dispensed via opening 118.

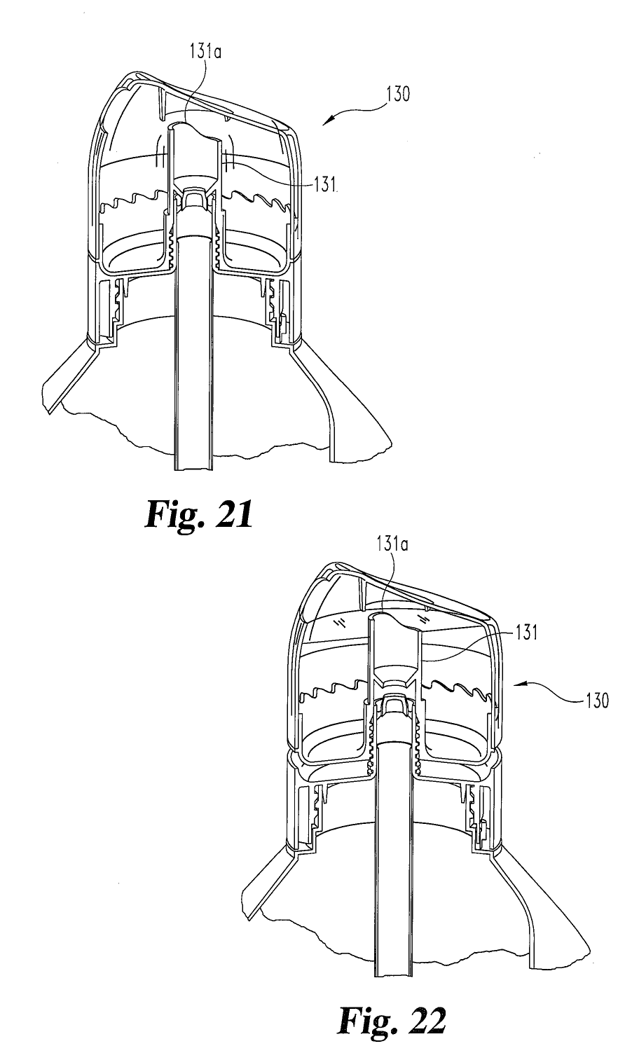

Referring to FIGS. 21 and 22, a modification to module 23 is illustrated. Module 130 is virtually identical to module 23 except for the size and shaping of the center spigot 131. The extended axial height and contouring of the upper edge 131a of spigot 131 reduces the risk of spillage through the spigot when tilting the module 130 in order to dispense the measured dose of product.

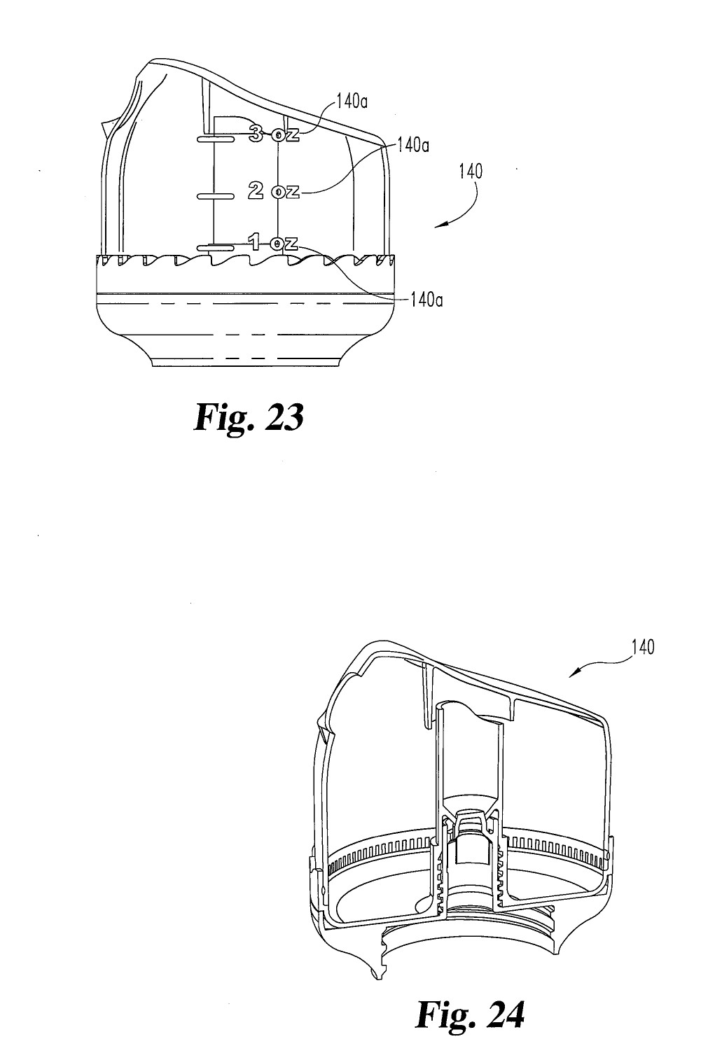

Referring to FIGS. 23 and 24, a further modification to module 23 is illustrated in the form of module 140. Module 140 includes volume markings 140a for the amount of product transferred from the container into the module 140. Other minor design modifications and refinements are illustrated in FIGS. 23 and 24, as representative of what would be one preferred commercial embodiment.

While the preferred embodiment of the invention has been illustrated and described in the drawings and foregoing description, the same is to be considered as illustrative and not restrictive in character, it being understood that all changes and modifications that come within the spirit of the invention are desired to be protected.

1. A satellite dosing system for transferring a volume of product from a larger container to a smaller module, said satellite dosing system comprising:
a closure constructed and arranged to attach to said container, said closure including a first flow conduit for transferring product from said container; and
a module constructed and arranged to attach to said closure and to be removed therefrom, said module including a second flow conduit and being movable relative to said closure between a closed-to-flow condition wherein said second flow conduit is closed and an open-to-flow condition wherein said second flow conduit is open to enable product to move from said container into said module, said module with product being movable to a remote dispensing site.

2. The satellite dosing system of claim 1 wherein said first flow conduit includes a tip and said second flow conduit defines a flow opening.

3. The satellite dosing system of claim 2 wherein said tip is aligned with said flow opening and said flow opening is movable to receive said tip to close said second flow conduit.

4. The satellite dosing system of claim 3 wherein said closure is threaded onto said container and said module is threaded onto said closure, said module being movable by retrograde rotation relative to said closure to open said flow opening without removing said module from said closure.

5. The satellite dosing system of claim 4 wherein said module defines a dispensing opening for removing product from within said module.

6. The satellite dosing system of claim 5 wherein the mechanism for moving product from the container into the module is by fluid pressure effected by squeezing the container.

7. The satellite dosing system of claim 1 wherein said closure is threaded onto said container and said module is threaded onto said closure, said module being movable by retrograde rotation relative to said closure to open said flow opening without removing said module from said closure.

8. The satellite dosing system of claim 1 wherein said module defines a dispensing opening for removing product from within said module.

9. The satellite dosing system of claim 1 wherein the mechanism for moving product from the container into the module is by fluid pressure effected by squeezing the container.

10. The satellite dosing system of claim 1 wherein said module has an open top for product dispensing.

11. The satellite dosing system of claim 1 wherein said module includes a bellows in flow communication with said second flow conduit.

12. The satellite dosing system of claim 11 wherein the mechanism for moving product from the container into the module is by fluid suction due to movement of said bellows.

13. A satellite dosing system for transferring a volume of product from a larger container to a syringe module, said satellite dosing system comprising:
a closure constructed and arranged to attach to said container, said closure including a first flow conduit for transferring product from said container; and
a syringe module constructed and arranged to attach to said closure via a Luer connection and to be removed therefrom, said syringe module including a second flow conduit and being movable relative to said closure between a closed-to-flow condition wherein said second flow conduit is closed and an open-to-flow condition wherein said second flow conduit is open to enable product to move from said container into said syringe module, said syringe module with product being movable to a remote dispensing site.

14. The satellite dosing system of claim 13 wherein said syringe module includes a body connected to said closure and a movable plunger received by said body.

15. The satellite dosing system of claim 14 wherein the mechanism for moving product from the container into the syringe module is by fluid suction due to suction movement of said plunger.
